(19) United States
(12) Patent Application Publication
(10) Pub. No.: US 2014/0115657 A1
(43) Pub. Date: Apr. 24, 2014

(54) Method of Reducing Fraud in System User Account Registration

(71) Applicant: Adekunle Ayodele, Snellville, GA (US)

(72) Inventor: Adekunle Ayodele, Snellville, GA (US)

(21) Appl. No.: 14/057,936

(22) Filed: Oct. 18, 2013

Related U.S. Application Data
(60) Provisional application No. 61/716,538, filed on Oct. 21, 2012.

(51) Int. Cl. G06F 21/64

(52) U.S. Cl. CPC G06F 21/64
USPC 726/1

(57) ABSTRACT

Provided is a method of reducing the creation of inappropriate or fraudulent accounts within a digital system. The method prompts a user for input of key biographical data and then initiates capture of a live video of the user. Video capture is accomplished via activation of a user's own webcam or other audio-video capture device. System software activates the audio-video capture device and instructs the device to continue recording for a predetermined period of time. The resultant multimedia file is stored in conjunction with the submitted biographical data in a database. System administrators review the multimedia file or appropriateness of content and check the file contents against the provided biographical data. If the file is inappropriate or the data does not match the file contents, the account creation request is denied and the account is deleted prior to activation on the system.

### CROSS REFERENCE TO RELATED APPLICATION

This application claims the benefit of U.S. Provisional Application No. 61/716,538 filed on Oct. 21, 2012. The patent application identified above is incorporated here by reference in its entirety to provide continuity of disclosure.

### BACKGROUND OF THE INVENTION

1. Field of the Invention

The present invention relates to methods of improving the integrity of system account registration. More specifically, it relates to a method of creating user accounts within a private system, whereby a user initiating account generation is required to permit live video capture via an audio-video recording device in operative communication with the user's computing device. By requiring live video capture during new account creation, the method links the account to a video record of the user, thereby reducing an individual's ability to associate fraudulent identification information with an account.

Digital communities such as forum groups, social networks, and commercial customer interfaces have long confronted the problem of fraudulent account creation. Individuals falsely purporting to be celebrities, politicians, and musicians generate accounts within a digital system and hold themselves out to be the celebrity in question. Another form of fraudulent use comes from those who claim to be of a different age or gender than their biostatistics conveyed. This tactic is often used by sexual predators and commercial solicitors to gain the trust of target users. Single incidents of fraudulent account creation may be difficult for system administrators to identify before problems arise. Compounded over a period of time, abuse by fraudulent account holders can degrade the trust capital of system users and ultimately destroy system integrity.

Physical communities offering members only features such as discount shopping centers, residential buildings, and social groups have addressed the problem of fraud by requiring in person membership creation. New members are often prompted for identifying information and user preferences during the registration process. Snapshots of the new member may be taken in order to link the identifying information with a visual depiction of the individual. After account creation, the member is granted access to community services pending authentication of their identifying information, usually by a quick visual check by a staff member to ensure that the visual depiction of the member matches the cardholder's visage.

The use of photo capture and facial recognition does not translate effectively to digital scenarios. Individuals can take photos from friends, family, and other websites and establish an account pretending to be that person. This strategy works particularly well for those individuals pretending to be a different age or gender. Because the user is never confronted in an in person setting, staff members and facial recognition are useless to debunk the user's fraudulent claims of identity.

Further, user accounts generated on most digital communities are not vetted or even reviewed by system staff for potentially fraudulent content. Pornographic materials, commercial solicitations, and offensive content are common types of inappropriate material inserted into user profile information, and even user visual depictions. Exposure to such content is not only offensive to many users, but can facilitate the proliferation of criminal activity if left unchecked.

A method is needed for account creation within a digital system that incorporates a live capture of video that is reviewed and approved by a system administrator to ensure that identifying information matches the captured visual depiction. The present invention provides such a method and thereby improves the integrity of digital closed communities via reduction of fraudulent account creation.

2. Description of the Prior Art

The present invention is a method of reducing fraudulent account creation in digital systems. The method includes prompting the user for biographical information and upon entry initiates operation of an audio-video capture device associated with the user's computer. This initiation is accomplished via a software containing instructions for activating audio-visual capture by the audio-visual capture device. Capture continues for a predetermined period of time. Once completed, the recorded multimedia file is stored in a database in association with the user's identifying information. The multimedia file is not immediately published for viewing by system users, but instead is reviewed by system administrators. In this way, the video depiction of a user is compared against identifying information to ensure that there is a match, and that no inappropriate content is present. Audio may be stripped from the multimedia file in preparation for deploying the multimedia file as a user's profile visual depiction. The list of references cited herein is deemed to be relevant to the present disclosure.

Desmarais, U.S. Patent Publication No. 2013/0086185 discloses a system and method of implementing a social media network. Specifically, Desmarais teaches “directing” a user to upload a multimedia recording (audio or video file) upon completion of the account generation process. Unlike the method of the present invention, the Desmarais social networking system does not utilize system software to initiate an audio-video capture device on a user's computing device. Nor does Desmarais require the live capture of an audio-video segment during the account creation process. Thus users of the Desmarais system are free to upload multimedia content that may depict themselves, or others, or inappropriate content; and does not address the problem of fraudulent account creation. The present invention solves this problem by requiring live video capture during, and as a barrier to, the registration process. The current method also includes steps of initiating a user's audio-video capture device via system software.

Turnbull, U.S. Pat. No. 8,370,912 teaches a method of automatic user account registration. The method can be used in social media networks, commercial business websites, or any other online service requiring user registration prior to the access of services. The method uses personal data stored within a mobile device to populate common user registration form fields, thereby eliminating the need for the user to manually input this information. Turnbull does not require the activation of an audio-video capture device associated with the mobile device, or capturing of live video during the information gathering process. Though Turnbull improves the registration process by making it substantially more convenient for new users, it does not protect system integrity against fraudulent account creation like the present invention.

Wagner, U.S. Pat. No. 8,381,286 teaches a method of authenticating users within a system. The method requires input of personal information, which is submitted to a server that then returns a personal identification number for use in future authentication sessions. Wagner discloses that the personal information may include audio, photo, or video in addition to the standard biographical data. But, Wagner does not require the capture of live audio-video during the registration process, nor does it disclose the initiation of a user's own audio-video capture device to affect said capture. The present invention is thus a significant advancement over Wagner because it incorporates live video capture into the account generation process by initiating the recording of audio-video files during registration and requires administrator approval of same, prior to account finalization.

Lastly, Barger, U.S. Patent Publication No. 2013/0198788 teaches a method for facilitating the upload of video files to a social media network. Video files may be captured using a camera associated with the user's mobile computing device, or attached as pre-existing multimedia files. The selected files are automatically uploaded to a user's social media account and published. This method does not require video capture during the social media network account generation process, nor does it disclose the initiation of the user's audio-video capture device by the social media network system. Barger differs in these respects from the present invention and is not sufficient in reducing incidents of fraudulent account creation within.

These prior art devices have several known drawbacks. These methods and systems do not disclose the steps of activating a user's audio-visual capture device in order to record a multimedia file of predetermined length. Nor do these methods and systems disclose the steps of reviewing a multimedia file to ensure correspondence with provided biographical data. Therefore these inventions do not effectively reduce creation of fraudulent account creation. He present invention addresses this failing by requiring live video capture during the account creation process and providing review by system administrators prior to publication of the user's account. It substantially diverges from the prior art and consequently it is clear that there is a need in the art for an improvement to existing user account creation methods. In this regard the instant invention substantially fulfills these needs.

### SUMMARY OF THE INVENTION

In view of the foregoing disadvantages inherent in the known types of user account creation methods now present in the prior art, the present invention provides a new live audio-visual capture process wherein the same can be utilized for providing convenience for the user when safely creating an account in a trust-worthy digital community

The present method is a means for reducing the number of fraudulent accounts created within system or a private digital community and restricting access to community services to legitimate users. Fraudulent accounts are those that purport to be created by a person other than the individual who actually created the account. Persons posing as celebrities, commercial solicitors posing as regular users, and individuals pretending to have a substantially different gender or age are examples of fraudulent accounts. Over time, exposure to such accounts can degrade the trust of legitimate users, driving them away from the community. To protect the precious trust capital of the system and preserve its integrity the present method reduces the ability of fraudulent users to obtain accounts in the first place. The method is therefore a means of proactive protection of a community's user base.

To accomplish the objective of the invention, the present method requires that a user seeking system access create an account and provide a live multimedia file depicting themselves. Live audio-visual capture is accomplished via activation of a user's webcam recording capabilities, or that of a similar audio-visual capture device in operative communication with the user's computing device. Because users can record inappropriate material during this live capture session, the resulting multimedia file is reviewed by system administrators and compared against biographical data provided by the user. If the multimedia file contains inappropriate material or the video depiction does not match the provided identifying information, then the user account will be denied and deleted from the system database. This method gives system administrators control over account creation and the ability to parse out fraudulent or inappropriate profiles before they are ever activated.

It is therefore an object of the present invention to provide a new and improved account creation method that has all of the advantages of the prior art and none of the disadvantages.

It is another an object of the present invention to provide a process for obtaining a live audio-visual file of a person requesting access to a digital system.

Another object of the present invention is to provide a method of reducing the number of inappropriate and fraudulent accounts that are created within a digital community.

Yet another object of the present invention is to provide a user account creation method that involves the vetting of potential accounts prior to their activation.

Still another object of the present invention is to provide a method that compares live videos of potential accountholders to their submitted biographical data to confirm a match therebetween.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a general diagram of an exemplary system upon which the method may be implemented.

FIG. 2 shows a flow chart of the user end of the account generation process.

FIG. 3 shows a flow chart of the system administrator end of the account generation process.

FIG. 4 shows an exemplary depiction of an account review summary as would be displayed to a system administrator.

FIG. 5 shows a flow chart of the account finalization process as completed by a system administrator.

### DETAILED DESCRIPTION OF THE INVENTION

Reference is made herein to the attached drawings. Like reference numerals are used throughout the drawings to depict like or similar elements of the account generation method. For the purposes of presenting a brief and clear description of the present invention, the preferred embodiment will be discussed as used for reducing the creation of fraudulent accounts within a digital system. The figures are intended for representative purposes only and should not be considered to be limiting in any respect.

The method discussed herein provides administrators of social networks or other online communities with a means for reducing instances of fraud within their user community. The invention accomplishes this by incorporating a requirement for the live capture of a video during the account generation process, and then subjecting the resultant multimedia file to scrutiny by system administrators. Reviewing submitted multimedia files to ensure that they are appropriate in nature and the depicted user appears to be the same as the person described in corresponding biographical data, system administrators can parse out accounts that are clearly deceptive. Further, the method provides for obtaining a permanent video record of community participants. The process reduces the creation of accounts that are visible fraudulent, such as those purporting to be held by celebrities, or those pretending to be an age or gender other than their own. Integrity of interactions between users is protected by thus removing predators and con artists from the pool of potential system participants.

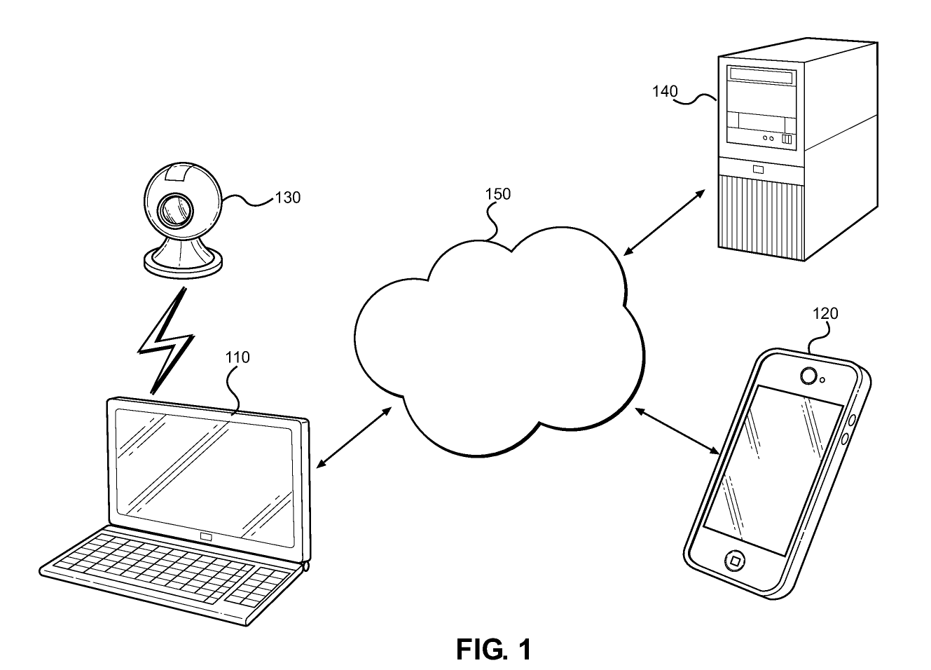

Referring now to FIG. 1, there is shown a diagram of an illustrative implementation of a network environment conducive to use of the present method. One or more client computing devices such as a laptop 110, tablet computer 120, smart phone, or desktop computer (hereinafter referred to generally as “client”) are in communication with at least one server 140 via a network 150. Each client is operatively and electrically connected to a text input means and a web-camera or other audio-video capture device 130. The use of the terms “client and server” in the singular is not intended to limit the method to a single client or single server embodiment. During the practice of the method, the network environment may include any number of client computing devices in communication with any number of servers over the network. Similarly, multiple networks may be employed to connect groups of servers or groups of client computing devices together, thereby creating sub-networks. In general, the term network is intended to refer to the “Internet”, but wide area networks (WAN) may also be used, and it will be understood by one of ordinary skill in the art that the method is not limited to implementation on only this network.

Each client and server is implemented as a computing device having a system bus in communication with at least the components of: a central processing unit; a main memory; a storage memory; an input/output (I/O) controller; display devices; and a network interface. An operating system and various software routines are stored on the storage memory. Input/Output devices such as a keyboard, touchpad, touchscreen, mouse, speakers, and the aforementioned audio-video capture device may be connected to the I/O controller. Of these devices only a text input means and, pointer device, and audio-visual capture device are necessary for the implementation of the present invention. Audio output via speakers is also desirable but is not required. The addition of further components or substitution of different configurations of a component will be known to one of ordinary skill in the art and are not enumerated in detail herein.

Each of said servers may run an application stack comprising but not limited to web servers, file upload/download servers, associated databases, and authentication applications. The upload/download server and databases may be integrated with the web server application. A web server includes sub-applications for hosting a website and providing client-side services, as well as facilitating client access to said one or more databases. It is preferable that document-oriented databases capable of indexing, sorting, and querying multimedia files be used in the implementation of the present method. Selected databases should be scalable to avoid limitations on effectiveness of the method. Partitioning strategies such as database sharing may be implemented to promote greater scalability. Clients can access these databases via a website hosted on said web server, pending successful login with the authentication application. Authentication may consist of password checking, credential verification, or confirmation of other identifying information.

In addition to storage of multimedia files, and one or more databases, the one or more servers shall also run a webserver to host an online portal such as a website (hereinafter referred to as “website). Implementation of the online portal is not limited to a particular language, client browser configuration, or design. It is preferable that the online portal is implemented using JAVA (Oracle Corporation of Redwood, Calif.) and Flash (Adobe Systems, Inc. of San Jose, Calif.). Other languages and web-based software applications may be substituted as needed by one of ordinary skill in the art to accomplish the steps described herein.

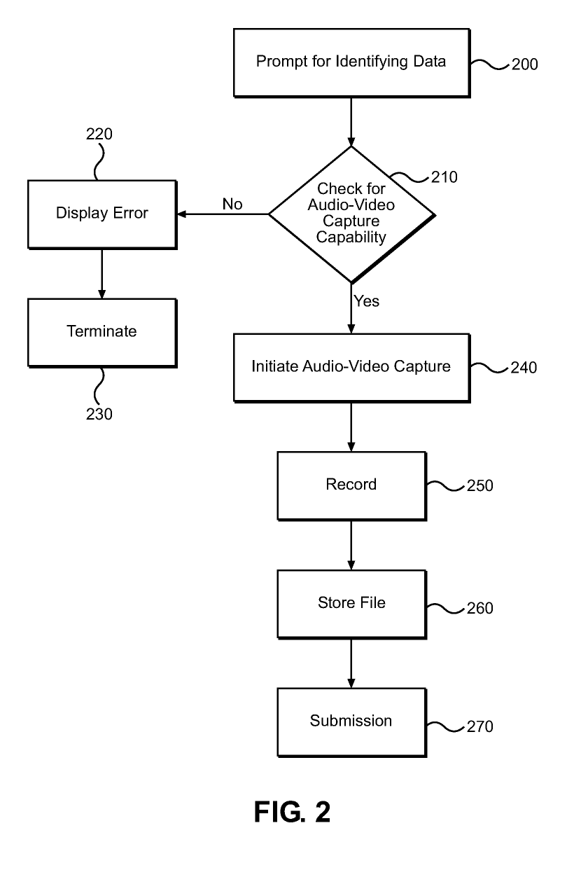

Referring now to FIG. 2, there is shown a diagram of the account creation process. To begin the process a client accesses the web site hosted on the web server. The potential user then interacts with an on-screen indicia presented via a web page, which is displayed in a client web browser. Examples of appropriate indicia are textual links stating “sign up, and buttons marked “create an account.” Interaction with the indicia results in the display of a prompt for the user to input identifying data 200. This prompt may be in the form of a new webpage, series of pop-up or overlay windows within the web browser. By way of example, a series of fields with textual prompts indicating the information to be entered into field may be displayed to the user. During this input process, users may have access to a link, pop-up window, or other notification means that provides information regarding a pre-determined set of use rules, which regulate the content of multimedia files.

Next, the web server accesses the client machine over the network and checks for an audio-video capture device in operative connection with the client I/O controller 210. Audio-video capture is an essential component of the present process, because multimedia file contents are reviewed by system administrators for signs of fraud. If the result of the capture device check is negative, an error message is displayed 220 to the user via the client screen and the process is terminated 230.

An audio-video capture device check that confirms an operational audio-video recording device returns a positive result to the server. The web server then communicates with the client machine, signaling the beginning of audio-video capture 240. Optionally, the capture may be preceded by an on-screen prompt indicating that a user should confirm their readiness to begin audio-video capture by interacting with indicia. Upon receipt of the communication from the server, the client computing device signals the I/O controller to initiate recording via the audio-video capture device 250. Recording continues for a predetermined period of time established by system administrators. A recording termination communication is sent to the client by the server at the end of the predetermined recording period, or at a time slightly preceding the end of the predetermined time interval. The client receives this termination communication and signals the I/O controller to cease recording.

Transmission and storage of captured audio-video 260 may be accomplished through several methods. In some embodiments, captured data is streamed over the network to the server for storage, during the capture process. Streamed data is received and stored on the server and indexed within the database. Alternatively, in other embodiments, captured data is stored locally on the storage memory and transmitted to the server upon completion of the capture process. In either embodiment, the resultant multimedia file is stored on the server and indexed within one of said databases. The database may be a separate structure designated for account generation request information, or alternatively, the information may be incorporated into a general user database.

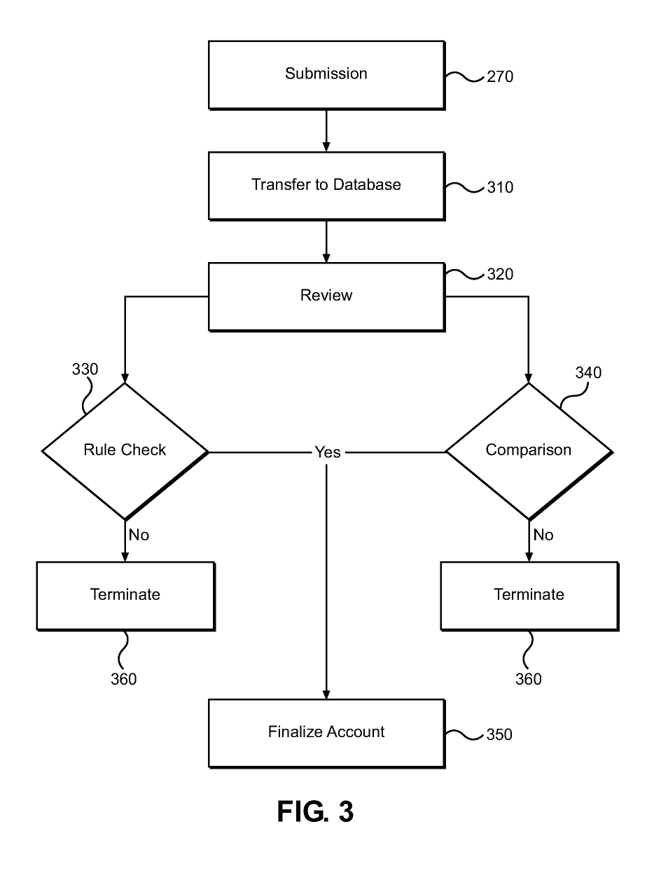

In some embodiments, a user is provided with an opportunity to review the captured video file prior to submission. The multimedia file may be played back in a web browser window and a user prompted for their approval of the captured clip. If the user does not approve the video, the audio-video capture process may repeat until the user is satisfied with the multimedia file produced. Alternatively, the initially captured audio-video file may be stored without prompting the user for his or her approval. In either embodiment, the process is not completed until submission of the input data and multimedia file 270. The account generation process is further depicted in FIG. 3. Upon submission the information and multimedia file are indexed within the database 310 and an identifier added, which indicates that the account is pending review.

Once submitted, requests are reviewed by a system administrator, who can approve or deny the request. Pending finalization of an account, the requesting user does not have access to web server services beyond those available to the general public. Private web services, upload/download server access, and database access are inaccessible to persons without finalized accounts.

System administrators view submitted account generation requests via an administrator portal that is preferably integrated into the web site running on the web server. Data input by the user is visible to a system administrator via the administrator interface along with the submitted multimedia file. Review of the requested account 320 comprises a two-part check of the submitted data and content. If both checks return positive results then the account is approved and finalized 350.

In some embodiments, the first check performed is a check for appropriateness of content 360. To reduce the inadvertent exposure of web site users to erotic, mature, or offensive content, the multimedia file captured during creation of the account generation request is reviewed to verify that it contains appropriate content 330. This review maybe a visual review of the multimedia file in which a reviewing administrator watches the entire length of the file playback. If the file contains material that is not in compliance with the pre-determined use rules, the administrator terminates the account generation process 360. It is preferred that termination results in the transmission of an e-mail, text, or other notification message to the user. The message may address the reasons for request denial, or may simply state that the request did not comply with the use rules.

In some embodiments, a comparison check is the first check performed. The order and duration of the comparison check 340 and appropriateness check 330 is immaterial, so long as each step is performed prior to finalization. Comparison checks may be performed by a system administrator viewing and listening to the multimedia file, or alternatively may be performed by facial recognition software scanning the multimedia file. The contents of the filed are compared against the submitted biographical data to discover any inconsistencies. By way of example, biographical data listing a female of 30 years should match the person depicted in the multimedia file. If the biographical data does not match the depicted person, the administrator terminates the approval process 360. In embodiments incorporating facial recognition software, a failed comparison returns an error to the administrator who then terminates the process. Positive matches from either a manual or automated comparison check results in a prompt for the administrator to finalize the account 350.

Once the account is finalized, the user is notified via e-mail, text, or other notification message, and access privileges are assigned. The user can then access some restricted portions of the website, upload multimedia files and participate in web site services. User sign-in via the authentication application may be required in order for a user to gain access to the aforementioned services.

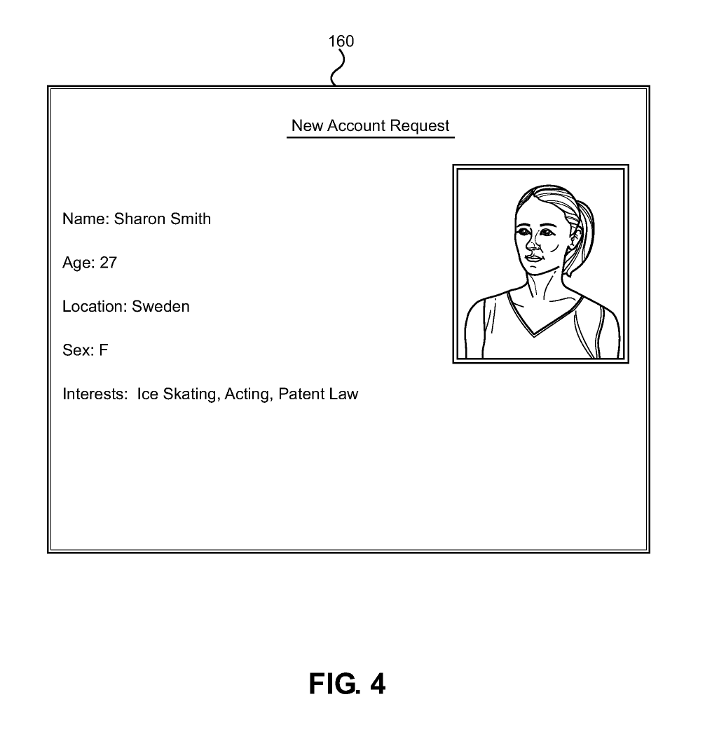

An exemplary illustration of the administrator interface is shown in FIG. 4. The administrator interface 160 is shown depicting a user account generation request. Biographical data and interests are displayed next to the captured video, thereby facilitating easy comparison. Submitted user information should be displayed in a concise format for easy review. Much of this information will later be displayed on the user's profile page and should be reviewed for appropriateness along with the multimedia file. The implementation of a review interface is not limited to the illustration of FIG. 4. Backend web portals are known to those of ordinary skill in the art and variations will be apparent to such individuals.

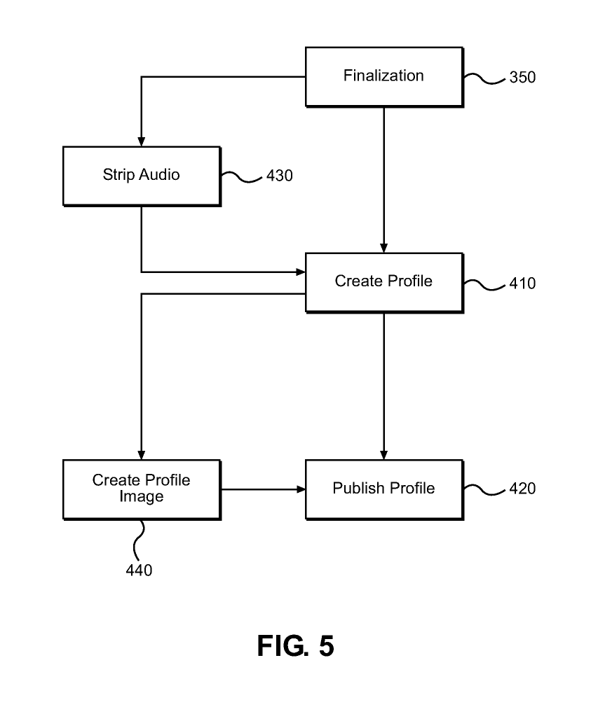

Turning now to FIG. 5, there is shown a flow diagram of the account finalization process. Finalization of the user account 350 begins after an administrator approves the account. In a primary embodiment, the system administrator selects an option to finalize the approved profile and the system creates a new user profile 410 then publishes the profile to the web site 420. Profile creation includes at least generating and indexing database entries of user account information and biographical data, creating of a default web page associated with the user, publishing of a portion of the biographical and interest information, and the captured multimedia file on the user profile page.

The finalization process includes two optional steps that may be implemented at the discretion of the system architect. A first step, audio-stripping 430, involves the removal of audio data from a submitted multimedia file. The resulting file is a silent video of predetermined length. Audio removal can reduce file size, and increase privacy of individual users. Thus the step enables effective storage of media files and protects each user's feeling of privacy. This step may be initiated by a system administrator or occur automatically upon account approval. In either embodiment, audio data is stripped using multimedia manipulation software included in the application stack on the one or more servers.

A second step, profile image creation 440 occurs during profile page generation. As with the audio-stripping step, the creation of a profile image 440 may be initiated by an administrator or may occur automatically during profile generation. The profile image is a digital still photo derived from the captured video. The still image is meshed with the captured video such that the still image is displayed until a pointer is moved over the image. Upon placement of a pointer over the region defined by the still image, the image is replaced with playback of the captured video. Profile images are published on a user's profile page along with their user information data

The method as described above increases accountability of potential users by requiring that they provide an audio-video clip of themselves prior to gaining access to a website or other digital community. Persons creating accounts under false identities are parsed out of the potential user pool during the review process. Community users can thus interact with other users with reduced concern about fraudulent users, predators, and solicitors.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A method of generating user accounts in a digital system, comprising the steps of:
prompting a user to input personal information;
checking for the presence of an audio-video capture device in operative communication with a user's computing device, wherein a lack of audio-video capture device results in termination of said method;
initiating capture of a multimedia file of said user;
recording said multimedia file for a pre-determined period of time;
storing said multimedia file;
submission of an account generation request comprising said personal information and said multimedia file by a user;
reviewing said account generation request for compliance with a predetermined rule set, and comparing playback of said multimedia file with said personal information for inconsistencies, wherein failure of said multimedia file to comply with said rule set or match said personal information results in termination of said method;
finalizing a user account based upon said personal information and said multimedia file.

2) The method of claim 1, wherein said step of prompting a user further comprises displaying a series of prompts on a screen of a user's computing device.

3) The method of claim 1, wherein said step of initiating capture further comprises the steps of:
transmitting an audio-video capture initiation signal from a server over a network to said client computing device;
receiving said audio-capture transmission signal by said client computing device;
activating said audio-video capture device.

4) The method of claim 1, wherein said pre-determined period of time is set by a system administrator.

5) The method of claim 1, wherein said step said recording of said multimedia file is terminated upon receipt by said client computing device of an audio-video capture termination signal sent by a server over a network.

6) The method of claim 1, wherein said step of storing said multimedia file comprises transmission of said file to a server having a storage memory upon which said multimedia file is stored.

7) The method of claim 1, wherein said step of submission further comprises the steps of:
indexing said personal information and said multimedia file within a database; and
denoting said personal information and multimedia file to indicate that review is pending.

8) The method of claim 1, wherein said step of reviewing is performed by a system administrator manually reviewing multimedia file playback.

9) The method of claim 1, wherein said step of reviewing is performed by software adapted to perform facial recognition.

10) The method of claim 1, wherein said step of finalizing further comprises the steps of:
creating a user profile web page;
publishing said user profile web page on a website, wherein said personal information and said multimedia are published on said user web page.

11) The method of claim 10 further comprising the step of:
stripping said multimedia file of audio prior to said step of creating said user profile web page;

12) The method of claim 10, further comprising the step of:
creating a profile image for publication during said step of publishing, wherein said profile image is derived from said multimedia file, and wherein said profile image begins playback of said multimedia file upon user interaction with said profile image.
